(19) United States
(12) Patent Application Publication
(10) Pub. No.: US 2005/0199591 A1
(43) Pub. Date: Sep. 15, 2005

(54) Method of forming a weld pad

(75) Inventors: Keith E. Coe, Hixson, TN (US); Bruce R. Newton, Buford, GA (US)

Correspondence Address: WESTINGHOUSE ELECTRIC COMPANY, LLC, P.O. BOX 355, PITTSBURGH, PA, 15230-0355, US

(73) Assignee: Westinghouse Electric Co. LLC

(21) Appl. No.: 11/075,494

(22) Filed: Mar. 9, 2005

Related U.S. Application Data
(60) Provisional application No. 60/551,373, filed on Mar. 9, 2004.

(51) Int. Cl. B23K 9/04

(52) U.S. Cl. 219/76.1

(57) ABSTRACT

A weld pad is built up between a pressure vessel and a sleeve extending through a penetration in its surface by continuously forming one or more weld layers that are attached to the pressure vessel and the sleeve.

### CROSS REFERENCE

This application for patent is a continuation of Provisional Patent Application No. 60/551,373 filed Mar. 9, 2004.

### BACKGROUND OF THE INVENTION

The invention relates to method of forming a weld pad on a pressure vessel and more particularly to a method of forming a weld pad that comprises a part of a pressure boundary. The invention is particularly useful as a repair or as a preventative repair. As used herein: the term “pressure vessel” includes metallic process vessels, heat exchangers, piping, components and systems designed to contain fluids at pressures higher than 15 psig; the term “sleeves” includes metallic sleeves, tubes, nozzles and the parts of instrumentation and other appurtenances or items that extend into penetrations in the shells of pressure vessels; and the term “weld pad” means a built-up joint comprised of multiple layers of weld deposits.

The sleeves extending through the external surfaces of pressure vessels and/or their welds may degrade as a result of micro-cracking, cracking, or other degradation/failure mechanisms during plant operation and/or plant transient conditions. Depending upon time, temperature, pressure and the corrosive nature of the contained fluid, these degradations may eventually develop into pathways through which fluids may leak from the pressure vessels. Thus, for example, after decades of operation at temperatures of up to about 600° F. or more and pressures of up to 2200 psi or more, indications of cracking have been detected in the course of non-destructive examinations of pressure vessels in light water nuclear reactor systems designed to generate commercial electric power. In some cases, small leaks have been detected in the sleeves extending through the heads of pressure vessels. In addition, suspected flaws or defects may have developed during original fabrication. The pressure vessels may be repaired to mitigate existing or suspected flaws or defects. Alternatively, repairs may be preemptively performed in locations of known susceptibility before flaws or defects have been identified.

Several repair options have been proposed or employed to remedy actually or potentially leaking sleeves of pressure vessels. Various full nozzle and partial nozzle (or “half nozzle”) welding repairs have been proposed, but such welding repairs undesirably tend to be very costly because they require several substeps involving extended periods of time to perform. In the 1990s, the Electric Power Research Institute and other entities developed “temperbead” welding techniques to eliminate the need for elevated temperature post weld heat treatments, but the temperbead processes themselves entail several time consuming substeps. See, in this regard, ASME Section III, NB-4622.11 entitled “Temper Bead Weld Repair To Dissimilar Metal Welds Or Buttering” for an overview of temperbead welding. See, also, ASME Section III, NB-4336 & Section IX, QW-202.3 and ASME Code Cases 432, 606 and 638 relating to temperbead welding processes and an Internet-available slide presentation by Bud Auvil of Welding Services, Inc. (“WSI”) entitled “Alloy 600 Repairs” relating to various proposed nozzle repair methods, including a partial nozzle repair method incorporating an ambient temperbead welding process. Also, less costly mechanical seal nozzle assemblies have been employed to replace susceptible sleeves in pressure vessels. See, in this regard, U.S. Pat. No. 5,918,911 and the patents cited therein. However, mechanical seal nozzle assembly repairs have not been satisfactory in all cases.

### SUMMARY OF THE INVENTION

It is an object to provide a method of forming a weld pad that eliminates many of the steps of the previously employed prior art welding methods. It is an additional object of the present invention to provide a welding method that is enables faster installation than the prior art welding methods that have been employed.

With these objects in view, the present invention resides in a method of forming a weld pad between a surface of a pressure vessel having a penetration extending to the surface and a sleeve extending in the penetration, which comprises continuously forming a first weld layer that is attached to the sleeve and to the surface of the pressure vessel. In preferred practices, additional weld layers are continuously formed over the first weld layer. Preferably, the weld pad is formed without intervening elevated temperature heat treatment steps or a post weld elevated temperature heat treatment step. In preferred practices where weld pads are employed in partial nozzle or full nozzle type of repairs, at least a portion of an original sleeve is removed from the penetration and a replacement sleeve is inserted into the penetration before the first weld layer is is formed. Advantageously, the continuous formation of each weld layer permits many of the previously required welding steps to be eliminated.

### BRIEF DESCRIPTION OF THE DRAWINGS

The invention as set forth in the claims will become more apparent from the following detailed description of certain preferred practices thereof and resulting repairs shown, by way of example only, in the accompanying drawings, wherein:

FIG. 1 is a partially broken away perspective view of a pressure vessel piped into a plant process;

FIG. 2 is a partial sectional view of the bottom head of the pressure vessel shown in FIG. 1 and a representative sleeve extending therethrough;

FIG. 3 is a partial sectional view of the bottom head of the pressure vessel shown in FIG. 1 with a sleeve remnant extending therein;

FIG. 4 is a partial sectional view of the bottom head of the pressure vessel shown in FIG. 1 that has been repaired in accordance with a first practice of the present invention;

FIG. 5 is a partial sectional view of the bottom head of the pressure vessel shown in FIG. 1 that has been repaired in accordance with a second practice of the present invention; and

FIG. 6 is a partial sectional view of the bottom head of the pressure vessel shown in FIG. 1 that has been repaired in accordance with a third practice of the present invention.

### DESCRIPTION OF THE PREFERRED PRACTICES

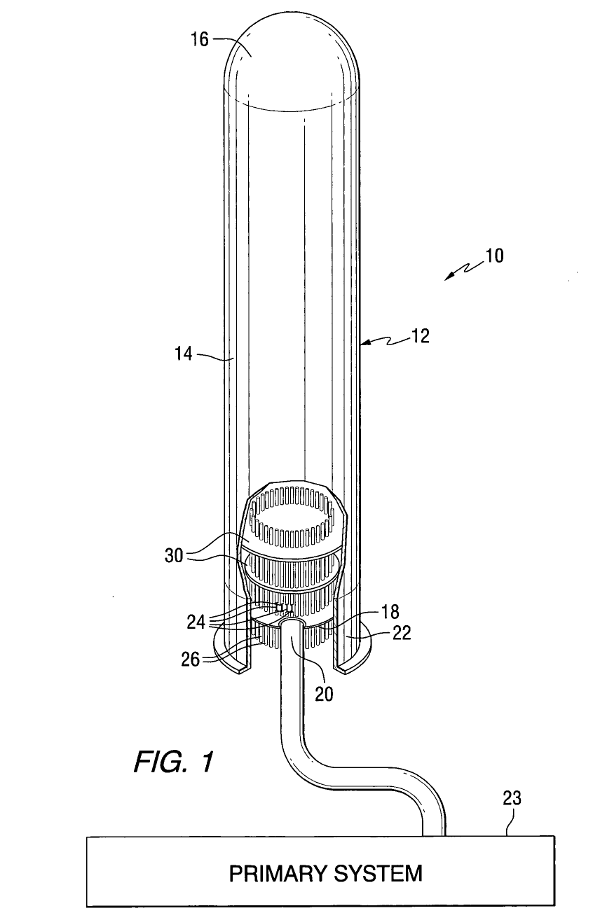

Referring now to the drawings in detail and in particular to FIG. 1, there is generally shown a pressure vessel 10 comprised of a shell 12 including a cylindrical body 14, a top head 16 and a bottom head 18 with a representative nozzle 20. The pressure vessel 10 generally has an inner surface 19 exposed to a contained fluid such as water, steam, air and other liquids and gases and an outer surface 21 exposed to ambient conditions of the local atmosphere. The heads 16 and 18 of pressure vessels may be welded to the cylindrical body 14 (as shown) or may be removably flanged to the cylindrical body 14 (not shown). As shown in FIG. 1, the pressure vessel 10 is vertically oriented and supported by a flanged skirt 22. Pressure vessels may also be oriented horizontally and may be supported by legs, pedestals, hangers or other means (not shown).

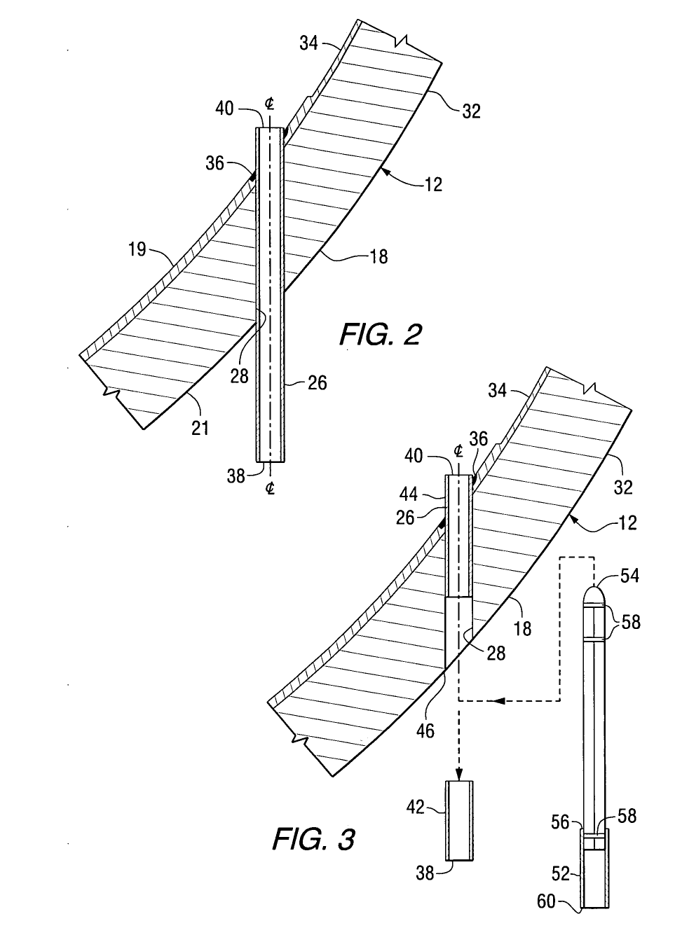

Because the present invention was made originally for repairing “pressurizer” vessels in pressurized water nuclear reactors for generating commercial electric power, the preferred practices of the invention will be described in the context of a repair to a pressurizer vessel. Thus, as shown in FIG. 1, the nozzle 20 is located in the bottom head 18 and is designed to be connected with the reactor's primary system 23 for permitting high temperature water to flow in and out of the pressurizer vessel 10 in order to maintain the nominal pressure of the primary system 23. Such pressurizer vessels may have volumes of up to 1000 cubic feet (280 cubic meters) or more. In addition, the pressurizer vessels may have up to 120 immersion electric heating elements 24 for maintaining the water at a nominal temperature. Such heating elements 24 may extend upwardly from sleeves (represented by sleeve 26 best seen in FIG. 2) extending vertically through penetrations 28 in the bottom head 18 and be supported by upper and lower support plates 30. Such sleeves 26 may have diameters of up to one inch (2.5 cm) or more. Pressure vessels 10 may also have nozzles for instrumentation, relief valves, vents and manways (not shown).

As is shown in FIG. 2, the shell 12 (including the bottom head 18) of a pressurizer vessel generally includes an outer structural member 32, which may be carbon or low alloy steel or other suitable alloy, and may include a liner 34, which may be stainless steel or other suitable alloy. The sleeves 26 may be fabricated of a nickel base alloy like Alloy 600 or 690 or other suitable alloy. The sleeves 26 are welded at the inner surface 19 of the pressure vessel 10 by welds 36. These welds are designed as pressure boundary welds; that is, the welds are designed to meet the operating pressure of the pressure vessel or higher. As shown, the representative sleeve 26 extends vertically through a highly curved portion of the bottom head 18 of a pressure vessel 10 and the associated weld 36 is a partial penetration type weld as defined by ASME Section III (or commonly referred to as a J-groove weld). It has been determined that J-groove welds generate substantial asymmetrical forces, which are partially responsible for cracking indications in these connections themselves and elsewhere in other primary systems of pressurized water reactors.

Before the present invention can be employed to build up a weld pad to repair pressure vessels such as the pressurizer vessel 10 shown in FIG. 1, the heating elements 24 (or other appurtenant objects) first must be removed. The heating elements 24 of pressurizer vessels 10 may be welded to the lower ends 38 of the sleeves 26. Thus, the weld between a heating element 24 and its associated sleeve 26 may be cut by a tool that can clamp on the sleeve 26. The cutting process may begin at the bottom of the weld and travel upwardly toward the sleeve 26. A shroud (not shown) may be placed under the tool to capture debris generated during the cutting process. After this weld is removed, the heating element 24 may be pulled from the sleeve 26 and the pressurizer vessel 10 repaired.

In the general practice of a partial nozzle repair, and as is shown in FIG. 3, a portion 42 of a sleeve 26 extending through the penetration 28 is removed and a remnant portion 44 is left extending in the penetration 28. Alternatively, in a full nozzle repair, the entire sleeve 26 would be removed. In a preferred partial nozzle repair practice, the sleeve 26 is cut about midwall within the penetration 28. The sleeve 26 may be severed by a rotatable cutting tool (not shown) that can be inserted into the sleeve 26, or alternatively the sleeve 26 may be removed or partially removed by a mechanical or thermal metal removal process that is generally initiated from the external vessel surface 21. When a remnant portion 44 of the existing sleeve 26 is left in place after the lower portion 42 is removed, the inner surface of the upper portion 44 then may be mechanically cleaned. In addition, the outer surface 46 of the pressure vessel shell 12 in the region around the penetration 28 may be examined to verify that it will accept a weld pad. Thus, for example, ASME Code Case 638 requires that an area extending the lesser of 1.5 times the component thickness or five inches from the edge of the penetration 28 be subjected to a liquid penetrant or magnetic particle examination.

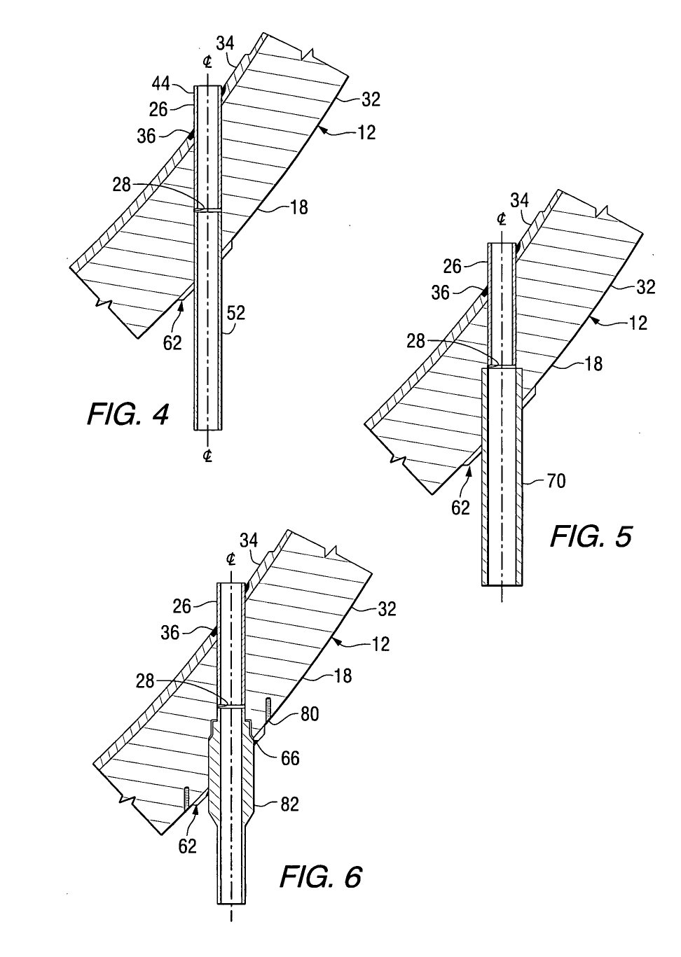

A replacement sleeve, such as the replacement sleeve 52 shown in FIGS. 3 and 4, may be inserted into the penetration 28 in place of at least a portion of the removed portion 42 of the original or first sleeve 26. The replacement sleeve 52 may be secured in the penetration 28 with an alignment fixture 54. Preferably, the replacement sleeve 52 will be spaced from the remnant portion 44 of the sleeve 26 by about a tenth of an inch or more where the remnant sleeve 44 and the replacement sleeve 52 are comprised of different materials. For example, the remnant sleeve 44 may be comprised of Alloy 600 and the replacement sleeve 52 may be comprised of Alloy 690. As shown in FIG. 3, the alignment fixture 54 may extend upwardly from the upper end 56 of the replacement sleeve 52 and may have locks 58 that may be extended radially to lock in place against the replacement sleeve 52 and the support plates 30 shown in FIG. 1. For applications requiring precise alignment, an alignment laser (not shown) or other alignment device may be inserted into the lower end 60 of the replacement sleeve 52 and aligned with a target (not shown) to effectively align the sleeve 52 with support plates 30 or other adjacent items. The alignment fixture 54 may remain in place to provide precision alignment monitoring during the subsequent welding steps.

A weld pad 62 is then formed between the pressure vessel 10 and the replacement sleeve 52 in the general practice of the present invention. Preferably, the weld pad 62 is a pressure boundary weld joint designed to maintain the operating pressure of the vessel. The weld pad 62 is formed by continuously forming a first weld layer on the pressure vessel 10 over the penetration 28 such that the first weld layer simultaneously attaches to both the pressure vessel external surface 46 and the replacement sleeve 52. In preferred practices, a series of weld beads are deposited circumferentially around and in contact with the replacement sleeve 52 and/or with the previously deposited weld beads, beginning at the intersection between the sleeve 52 and the pressure vessel 10, and extending outwardly of the sleeve 52 in a series of weld passes of gradually increasing diameters. Once the outermost weld pass satisfies pad design requirements for diameter, the first weld layer is complete.

A second weld layer is then continuously formed on the first weld layer. Depending upon the design pressure, a plurality of second weld layers may be formed over the first weld layer. The second and subsequent weld layers are preferably formed in a manner similar to the formation of the first weld layer. Thus, each additional layer preferably begins at the sleeve 52 and subsequent weld passes of gradually increasing diameters deposit weld beads until the first layer is essentially covered.

In a preferred practice for repairing the sleeves 26 extending through the penetrations 28 in the bottom heads 18 of pressurizer vessels 10, a minimum of three layers of weld filler material will be built up on the pressurizer bottom head 18 over the penetration 28 to form a weld pad 62 adjacent to the replacement heater sleeve 52. ASME Code Case N-638 requires that the minimum thickness of the weld pad 62 be no less than one eighth of an inch. As an integral part of the installation of this weld pad 62, the inner portion of each weld layer will attach directly to the replacement sleeve exterior surface using the same welding process. Thus, the first weld layer and all additional weld layers constitute an integral butter and J-weld. Non-destructive (liquid penetrant) examinations may be conducted during weld installation at about one half thickness and later at the final weld pad thickness. In cases where the final welds are to be ultrasonically examined, the weld surfaces may require minimal grinding or other final surface preparation to assure complete contact between a transducer and the surface of the weld 62. The weld filler metal may be Alloy 52 or other suitable alloy where the replacement sleeve 52 is comprised of Alloy 690, Stainless Steel Alloy, or other suitable alloy and the pressure vessel is comprised of carbon or low alloy steel.

An ambient temperature temperbead welding process is preferably employed because this eliminate the need for intervening or post welding elevated temperature heat treatments. However, conventional temperbead welding processes may be alternatively employed even though they require elevated temperature heat treatments if desired. Advantageously, temperbead welding techniques will deposit weld beads in controlled patterns such that successive beads provide heat-tempering to the base material heat affected zone directly below or immediately adjacent. Machine gas tungsten arc welding may be employed to form the temperbead weld and to provide substantially smooth surfaces that will require little or no machining or grinding or other surface preparation.

In an another practice, additional later formed weld layers may be stepped out radially from the sleeve 52 to form a groove, and a J-weld then continuously formed in the groove by a temperbead technique and the same welding machine that formed the earlier weld layers.

Advantageously, the continuous welding step of the present invention eliminates the need for drilling to remove the sacrificial plug associated with the temperbead pad, eliminates the need for excavating a J-groove in the weld pad, and eliminates the need for subsequently inserting the replacement nozzle and installing a weld in the J-groove excavation to attach the pad to the replacement nozzle, each of which is required by the above-identified WSI presentation entitled “Alloy 600 Repairs”. Also, weld pads 62 formed by the continuous welding step of the present invention may be thinner, and may be smaller in diameter than weld pads formed by prior art practices. Thus, a weld pad 62 generated by a continuous welding step of the present invention may be less than half the diameter of conventional seven to nine inch pads and less than half the thickness of half inch thick conventional pads, including the one half inch thick weld pad described by the above-identified WSI presentation for repairing pressurizer vessels. A smaller weld pad 62 developed in accordance with the present invention may be more rapidly built up and less likely to overlap a weld pad of an adjacent sleeve of a pressurizer vessel or other component.

Advantageously, repairs made in radioactive environments may result in reduced exposure to welding technicians. It has been conservatively estimated based upon an assumed dose rate of 100 mRem/hr under a pressurizer vessel, that a prior art weld repair (involving a conventional weld pad with a large diameter and thickness) would require:
approximately 18 hours/pad to build up the weld pad, which would result in an exposure of 90-180 mRem/pad (assuming that approximately 5-10% of the time would require a welding technician be under the pressurizer vessel);
approximately 1 hour/sleeve to grind a J-groove in each pad, which would result in an exposure of 100 mRem/pad; and
approximately 0.75 hour to weld the pad to the replacement sleeve, which would result in an exposure of 75 mRem/sleeve.
   Based upon the assumed dose rate of 100 mRem/hr, it has been estimated that a weld repair for the same application in accordance with the present invention would require:
approximately 6 hours to make an integral weld, which would result in an exposure of 30-60 mRem/pad (assuming that approximately 5-10% of the time would require a welding technician be under the pressurizer vessel);
no additional time for the eliminated step of machining a J-groove in the weld pad; and
no additional time for the step of welding the pad to the replacement sleeve. Thus, it has been estimated that the present invention can be expected to save over 12 hours and 200 mRem/sleeve in comparison with prior art practices.

FIG. 5 shows a repair made in accordance with a second preferred practice of the present invention where the penetration 28 is machined to a true diameter before inserting a replacement sleeve 70 having a larger diameter than the original sleeve 26.

FIG. 6 shows a repair made in accordance with a third preferred practice of the present invention to a previously installed mechanical nozzle seal assembly (not shown). FIG. 6 generally shows a replacement sleeve 82 which was originally a sleeve member of the seal assembly penetration 28 and an integral weld pad 62 comprising a J-groove weld 66. In an alternative design (not shown), each of the layers of the weld pad 62 attaches to the sleeve 82 without the formation by the uppermost weld layers of a groove adjacent the sleeve 82 and J-groove weld. Preferably, the weld pad 62 does not extend to the bolt holes 80 associated with the mechanical nozzle seal assembly. Similarly, integral weld pads may be built up between the external carbon steel surfaces of reactor pressure vessel heads and bottom mounted Alloy 600 instrument nozzles extending from suspect welds with stainless steel liners to form a pressure boundary.

While a present preferred embodiment of the present invention has been shown and described, it is to be understood that the invention may be otherwise variously embodied within the scope of the following claims of invention.

1. A method of forming a weld pad between a surface of a pressure vessel having a penetration extending to the surface, and a sleeve extending in the penetration, comprising the step of:
continuously forming a first weld layer attached to the sleeve and to the surface.

2. The method of claim 1, wherein the first weld layer is formed by:
depositing weld beads into contact with previously deposited weld beads.

3. The method of claim 1, including the step of:
continuously forming at least one additional weld layer over the first weld layer.

4. The method of claim 3, wherein the at least one additional weld layer is formed over the first weld layer without a prior elevated temperature heat treatment step or a post weld elevated temperature heat treatment step.

5. The method of claim 3, wherein at least two additional continuously formed weld layers are formed over the first weld layer.

6. The method of claim 5, wherein a weld pad having a thickness of no less than an eight of an inch is formed.

7. The method of claim 5, wherein the step of forming the at least two additional continuously formed weld layers includes attaching the at least two additional weld layers to the sleeve.

8. The method of claim 7, wherein the step of forming the at least two additional continuously formed weld layers includes attaching all of the additional weld layers to the sleeve.

9. The method of claim 3, wherein the penetration extends to a second surface of the pressure vessel and the sleeve is attached to the pressure vessel by a second weld at the second surface.

10. The method of claim 3, wherein the pressure vessel has an adjacent sleeve extending in an adjacent penetration and the sleeves are welded to the pressure vessel by spaced apart weld pads.

11. The method of claim 3, wherein the method comprises:
removing at least a portion of a first sleeve from the penetration and inserting a replacement sleeve into the penetration before continuously forming a first weld layer attached to the replacement sleeve and to the surface.

12. The method of claim 11, wherein a portion of the first sleeve is removed from the penetration and a remnant portion of the first sleeve remains in the penetration and wherein the replacement sleeve is inserted into the penetration to replace the removed portion of the first sleeve.

13. The method of claim 11, wherein the entire first sleeve is removed from the penetration and replaced by the replacement sleeve.
